(19) United States
(12) Patent Application Publication
(10) Pub. No.: US 2025/0113752 A1
(43) Pub. Date: Apr. 10, 2025

(54) CONTROL SYSTEM FOR AN AGRICULTURAL TILLAGE IMPLEMENT

(71) Applicant: CNH Industrial America LLC, New Holland, PA (US)

(72) Inventors: Michael W. Glennon, Normal, IL (US); Derek Sicheneder, Morton, IL (US); William E. Allen, Peoria, IL (US); Federico Eduardo Palacios, Normal, IL (US)

(21) Appl. No.: 18/906,628

(22) Filed: Oct. 4, 2024

Related U.S. Application Data
(60) Provisional application No. 63/588,499, filed on Oct. 6, 2023.

(51) Int. Cl. A01B 63/22; A01B 29/04; A01B 63/32; A01B 79/00

(52) U.S. Cl. CPC A01B 63/22; A01B 29/048; A01B 63/32; A01B 79/00

(57) ABSTRACT

A control system for an agricultural tillage implement includes a controller configured to receive a first pressure sensor signal indicative of a first fluid pressure within a rolling basket cylinder and a second pressure sensor signal indicative of a second fluid pressure within a wheel frame actuator. The rolling basket cylinder is configured to couple to a main frame and to a rolling basket frame, and the wheel frame actuator is configured to control a position of a wheel frame relative to a hitch assembly. The controller is also configured to decrease a target fluid pressure in response to the second fluid pressure being below a minimum wheel frame actuator pressure threshold, and the controller is configured to control a tilt force applied to the main frame to maintain the first fluid pressure within a range of the target fluid pressure.

### CROSS-REFERENCE TO RELATED APPLICATION

This application claims priority from and the benefit of U.S. Provisional Application Ser. No. 63/588,499, entitled “CONTROL SYSTEM FOR AN AGRICULTURAL TILLAGE IMPLEMENT”, filed Oct. 6, 2023, which is hereby incorporated by reference in its entirety.

### BACKGROUND OF THE INVENTION

The present disclosure relates generally to a control system for an agricultural tillage implement.

Certain agricultural implements include ground engaging tools configured to interact with soil. For example, a tillage implement may include disc blades configured to break up a top layer of the soil for subsequent planting or seeding operations. The disc blades may be arranged in a front row and a rear row. As the tillage implement traverses a field, the forces acting to drive the disc blades into the soil may become unbalanced, thereby resulting in variations in the penetration depth of the disc blades (e.g., at least the disc blades of the rear row). Accordingly, the disc blades may break up the top layer of the soil at varying depths, which may reduce the effectiveness of the tillage operation.

### SUMMARY OF THE INVENTION

In certain embodiments, a control system for an agricultural tillage implement includes a controller having a memory and a processor. The controller is configured to receive a first pressure sensor signal indicative of a first fluid pressure within a rolling basket cylinder and a second pressure sensor signal indicative of a second fluid pressure within a wheel frame actuator. The rolling basket cylinder is configured to couple to a main frame and to a rolling basket frame, the wheel frame actuator is configured to couple to a wheel frame and to a hitch assembly, and the wheel frame actuator is configured to control a position of the wheel frame relative to the hitch assembly. The controller is also configured to decrease a target fluid pressure in response to the second fluid pressure being below a minimum wheel frame actuator pressure threshold. Additionally, the controller is configured to control a tilt force applied by a tilt actuator to the main frame to maintain the first fluid pressure within a threshold fluid pressure range of the target fluid pressure. The tilt actuator is configured to couple to the hitch assembly and to apply the tilt force to the main frame.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a perspective view of an embodiment of a tillage implement having a control system;

FIG. 2 is a perspective view of a portion of the tillage implement of FIG. 1;

FIG. 3 is a schematic view of an embodiment of a control system that may be employed within the tillage implement of FIG. 1; and

FIG. 4 is a flow diagram of an embodiment of a method for controlling a tilt actuator of a tillage implement.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

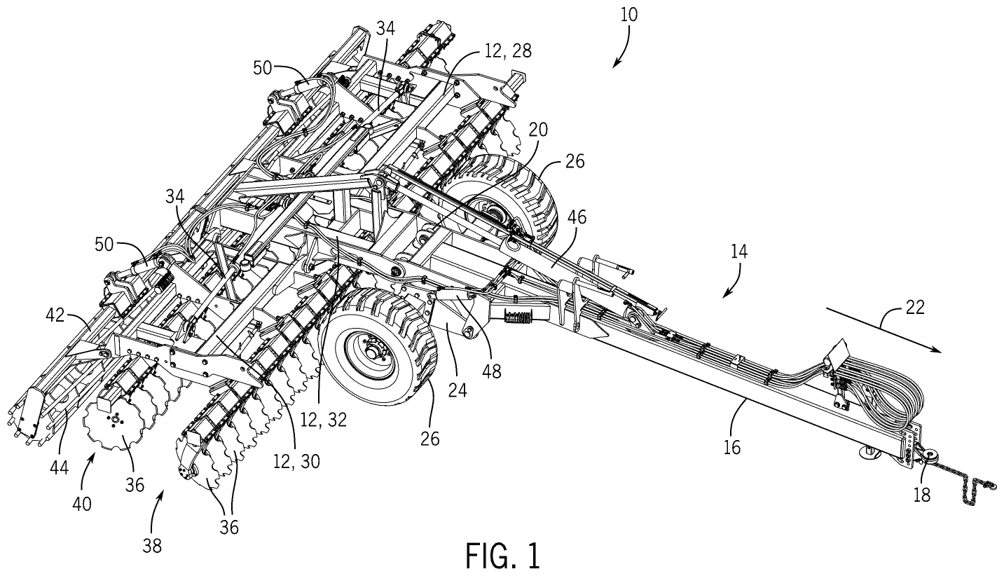

FIG. 1 is a perspective view of an embodiment of a tillage implement 10 (e.g., agricultural tillage implement) having a control system. In the illustrated embodiment, the tillage implement 10 is a high speed compact tillage implement having multiple ground engaging tools configured to till soil. As illustrated, the tillage implement 10 includes a main frame 12 and a hitch assembly 14 pivotally coupled to the main frame 12. In the illustrated embodiment, the hitch assembly 14 includes a hitch frame 16 and a hitch 18. The hitch frame 16 is pivotally coupled to the main frame 12 via pivot joint(s) 20, and the hitch 18 is configured to couple to a corresponding hitch of a work vehicle (e.g., tractor), which is configured to tow the tillage implement 10 through a field along a direction of travel 22.

Furthermore, the tillage implement 10 includes a wheel frame 24 pivotally coupled to the hitch frame 16 of the hitch assembly 14. In the illustrated embodiment, the tillage implement 10 includes two wheels 26 rotatably coupled to the wheel frame 24. The wheels 26 are configured to engage a surface of the field and to support a portion of the weight of the tillage implement 10 as the tillage implement 10 is towed through the field along the direction of travel 22. While the tillage implement 10 includes two wheels 26 in the illustrated embodiment, in other embodiments, the tillage implement may include more or fewer wheels rotatably coupled to the wheel frame (e.g., 1, 3, 4, 5, 6, or more). Furthermore, in certain embodiments, the tillage implement may include one or more tracks (e.g., alone or in combination with one or more wheels). While the wheel frame is coupled to the hitch frame by a pivotal connection in the illustrated embodiment, in other embodiments, the wheel frame may be movably coupled to the hitch frame by another suitable connection (e.g., sliding connection, linkage assembly, etc.) that facilitates adjustment of a vertical position of the wheels relative to the hitch frame.

In the illustrated embodiment, the main frame 12 includes a left wing section 28 and a right wing section 30. Each wing section is pivotally coupled to a center section 32 of the main frame 12. Furthermore, the tillage implement 10 includes wing actuators 34 configured to urge each wing section downwardly relative to the center section 32. Each wing actuator 34 is coupled to the center section 32 and to a respective wing section. While the main frame 12 includes the center section 32, the left wing section 28, and the right wing section 30 in the illustrated embodiment, in other embodiments, the main frame may include more or fewer sections. For example, in certain embodiments, the main frame may be substantially rigid (e.g., not including any wing sections). In such embodiments, the wing actuators may be omitted. Furthermore, the main frame 12 may be formed from multiple frame elements (e.g., rails, tubes, braces, etc.) coupled to one another (e.g., via welded connection(s), via fastener connection(s), etc.).

In the illustrated embodiment, the tillage implement 10 includes disc blades 36 configured to engage a top layer of the soil. As the tillage implement 10 is towed through the field along the direction of travel 22, the disc blades 36 are driven to rotate, thereby breaking up the top layer of the soil. In the illustrated embodiment, the disc blades 36 are arranged in a front row 38 and a rear row 40. However, in other embodiments, the disc blades may be arranged in more or fewer rows (e.g., 1, 3, 4, 5, 6, or more). Furthermore, in the illustrated embodiment, each disc blade 36 is independently mounted to the main frame 12. Accordingly, each disc blade 36 may rotate independently of the other disc blades 36. While each disc blade 36 is independently mounted to the main frame 12 in the illustrated embodiment, in other embodiments, at least a portion of the disc blades may be mounted to the main frame in one or more gangs, in which the disc blades of each gang are configured to rotate together as the tillage implement is towed through the field.

Furthermore, in the illustrated embodiment, the tillage implement 10 includes a rolling basket frame 42 pivotally coupled to the main frame 12. The tillage implement 10 also includes a rolling basket 44 rotatably coupled to the rolling basket frame 42. As the tillage implement 10 is towed through the field along the direction of travel 22, the rolling basket 44 is driven to rotate, thereby sizing soil clods, leveling the soil surface, smoothing the soil surface, or a combination thereof. In the illustrated embodiment, the rolling basket frame 42 includes a left section pivotally coupled to the left wing section 28 of the main frame 12, and the rolling basket frame 42 includes a right section pivotally coupled to the right wing section 30 of the main frame 12. In addition, the rolling basket 44 includes a left section rotatably coupled to the left section of the rolling basket frame 42, and the rolling basket 44 includes a right section rotatably coupled to the right section of the rolling basket frame 42. In certain embodiments (e.g., in embodiments in which the main frame is substantially rigid), the rolling basket frame may have a single section, and/or the rolling basket may have a single section. In addition, in certain embodiments (e.g., in embodiments in which the main frame includes more than two sections), each rolling basket frame section may be pivotally coupled to a respective main frame section, and each rolling basket section may be rotatably coupled to a respective rolling basket section.

While the tillage implement includes the disc blades 36 and a rolling basket 44 in the illustrated embodiment, in other embodiments, the tillage implement may include other/additional ground engaging tool(s). For example, in certain embodiments, the tillage implement may include tillage point assemblies (e.g., positioned behind the disc blades and in front of the rolling basket relative to the direction of travel) configured to engage the soil at a greater depth than the disc blades, thereby breaking up a lower layer of the soil. Each tillage point assembly may include a tillage point and a shank. The shank may position the tillage point at a target depth beneath the soil surface, and the tillage point may break up the soil. The shape of each tillage point, the arrangement of the tillage point assemblies, and the number of tillage point assemblies may be selected to control tillage within the field. Furthermore, in certain embodiments, the tillage implement may include finishing discs (e.g., positioned behind the disc blades and in front of the rolling basket relative to the direction of travel). In such embodiments, as the tillage implement is towed through the field, the finishing discs may be driven to rotate, thereby sizing soil clods, leveling the soil surface, smoothing the soil surface, cutting residue on the soil surface, or a combination thereof. In addition, in certain embodiments, the tillage implement may include one or more other/additional suitable ground engaging tools, such as coulter(s), opener(s), tine(s), other suitable ground engaging tool(s), or a combination thereof. Furthermore, while the tillage implement 10 is a high speed compact tillage implement in the illustrated embodiment, in other embodiments, the tillage implement may be a primary tillage implement, a vertical tillage implement, or another suitable type of tillage implement.

In the illustrated embodiment, the tillage implement 10 includes a tilt actuator 46 coupled to the hitch frame 16 of the hitch assembly 14 and to the main frame 12. The tilt actuator 46 is configured to apply a tilt force to the main frame 12, thereby urging the main frame 12 toward the surface of the field. Accordingly, the disc blades 36 and the rolling basket 44 may be driven into the soil. The tilt actuator 46 may include any suitable type of actuator, such as a hydraulic cylinder, a pneumatic cylinder, an electric linear actuator, a hydraulic motor, a pneumatic motor, an electric motor, etc. Furthermore, while the tillage implement 10 includes a single tilt actuator 46 in the illustrated embodiment, in other embodiments, the tillage implement may include additional tilt actuator(s) (e.g., 1, 2, 3, 4, or more additional tilt actuator(s)).

Furthermore, in the illustrated embodiment, the tillage implement 10 includes one or more wheel frame actuators 48, in which each wheel frame actuator 48 is coupled to the wheel frame 24 and to the hitch frame 16 of the hitch assembly 14. Each wheel frame actuator 48 is configured to control the position of the wheels 26 relative to the hitch frame 16, thereby controlling the position of the pivot joint(s) 20 relative to the surface of the field. As a result, the wheel frame actuators 48 are configured to control the height of the main frame 12 (e.g., at least a front portion of the main frame 12) relative to the surface of the field, thereby controlling the penetration depth of the disc blades 36 (e.g., at least the front row 38 of disc blades 36) into the soil. Each wheel frame actuator 48 may include any suitable type of actuator, such as a hydraulic cylinder, a pneumatic cylinder, an electric linear actuator, a hydraulic motor, a pneumatic motor, an electric motor, etc. Furthermore, while the tillage implement 10 includes two wheel frame actuators 48 in the illustrated embodiment, in other embodiments, the tillage implement may include more or fewer wheel frame actuators (e.g., 1, 3, 4, 5, 6, or more).

In addition, in the illustrated embodiment, the tillage implement 10 includes one or more rolling basket cylinders 50, in which each rolling basket cylinder 50 is coupled to the main frame 12 and to the rolling basket frame 42. Each rolling basket cylinder 50 may include any suitable type of cylinder, such as a hydraulic cylinder or a pneumatic cylinder. Furthermore, in the illustrated embodiment, the tillage implement 10 includes one rolling basket cylinder 50 for each section of the rolling basket frame 42. However, in other embodiments, the tillage implement may include multiple rolling basket cylinders for at least one rolling basket frame section (e.g., 2, 3, 4, or more). Furthermore, in embodiments in which the rolling basket frame has a single section, the tillage implement may include any suitable number of rolling basket cylinders for the single section (e.g., 1, 2, 3, 4, or more). The penetration depth of the disc blades 36 may be adjusted by controlling the extension of the wheel frame actuator(s) 48 and the extension of the rolling basket cylinder(s) 50.

As discussed in detail below, the tillage implement 10 includes a control system having a controller. The controller includes a memory and a processor, and the controller is communicatively coupled to the tilt actuator 46 and to the wheel frame actuator(s) 48. The controller is configured to receive a pressure sensor signal indicative of a fluid pressure within the rolling basket cylinder(s) 50, a pressure sensor signal indicative of a wheel pressure associated with the wheels 26 (e.g., the fluid pressure within the wheel frame actuator(s) 48), or a combination thereof. Furthermore, the controller is configured to control the tilt force applied by the tilt actuator 46 to the main frame 12 to maintain the fluid pressure within a threshold fluid pressure range of a target fluid pressure. Maintaining the fluid pressure within the threshold fluid pressure range of the target fluid pressure may substantially maintain the penetration depth of the disc blades 36 (e.g., at least the rear row 40 of disc blades 36) as the tillage implement 10 is towed along the field in the direction of travel 22 (e.g., as the tillage implement 10 encounters bumpy terrain). As a result, the disc blades 36 of the tillage implement 10 may break up the top layer of the soil at a consistent depth, thereby enhancing the effectiveness of tillage operations. For example, while the tillage implement 10 is operating within a region of denser soil, the controller may control the tilt actuator 46 to increase the tilt force applied to the main frame 12 to maintain the fluid pressure within the threshold fluid pressure range of the target fluid pressure, thereby increasing the longitudinal rigidity of the tillage implement 10. In addition, while the tillage implement 10 is operating within a region of less dense soil, the controller may control the tilt actuator 46 to decrease the tilt force applied to the main frame 12 to maintain the fluid pressure within the threshold fluid pressure range of the target fluid pressure, thereby reducing the longitudinal rigidity of the tillage implement 10.

The controller may adjust the target fluid pressure based on a wheel pressure (e.g., the fluid pressure within the wheel frame actuator(s) 48) such that the rolling basket 44 and the wheels 26 are maintained at respective target positions relative to the surface of the field (e.g., wheels in contact with the surface of the field, rolling basket at a target depth). Maintaining the rolling basket 44 and the wheels 26 at the respective target positions relative to the surface of the field may substantially reduce or eliminate plugging of the rolling basket 44 and may, thus, enhance the effectiveness of tillage operations. The controller may determine that the pressure within the pressure has fallen below a minimum threshold pressure (e.g., between 500 pounds per square inch and 600 pounds per square inch). The wheel pressure falling below the minimum threshold pressure may indicate, for instance, that the wheels 26 have lost contact with the surface of the field, which may indicate that the rolling basket cylinder(s) 50 are applying excessive force to the rolling basket 44 (e.g., which may cause a plugging condition of the rolling basket 44). In response, the controller may adjust (e.g., decrease) the target fluid pressure, thereby reducing the force applied by the rolling basket 44 to the surface of the field. As a result, the wheels 26 may regain contact with the surface of the field and the plugging condition may be terminated.

Additionally or alternatively, the controller may determine that the wheel pressure is above (e.g., greater than) a maximum threshold pressure. Such cases may indicate that the rolling basket 44 is sufficiently supported by the main frame 12 and that the fluid pressure may be increased without incurring a plugging condition of the rolling basket 44. As such, the controller may adjust (e.g., increase) the target fluid pressure such that the rolling basket reaches the target position relative to the surface of the field (e.g., target depth as specified by the operator).

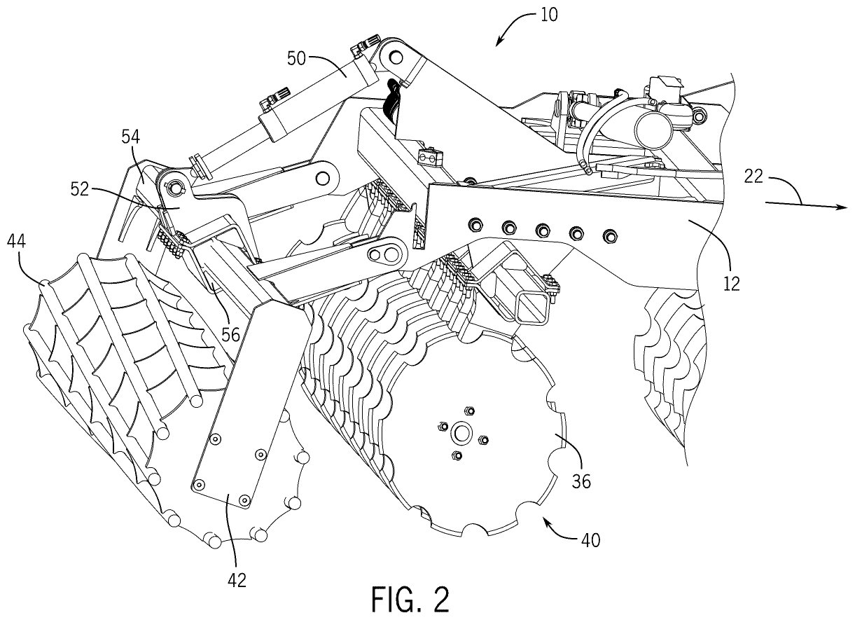

FIG. 2 is a perspective view of a portion of the tillage implement 10 of FIG. 1. As previously discussed, the rolling basket frame 42 is pivotally coupled to the main frame 12, and the rolling basket 44 is rotatably coupled to the rolling basket frame 42. As the tillage implement 10 is towed through the field along the direction of travel 22, the rolling basket 44 is driven to rotate, thereby sizing soil clods, leveling the soil surface, smoothing the soil surface, or a combination thereof. Furthermore, the rolling basket cylinder(s) 50 are coupled to the main frame 12 and to the rolling basket frame 42.

In the illustrated embodiment, each rolling basket cylinder 50 is pivotally coupled to a respective mount 52, and each mount 52 is disposed about a frame member 54 (e.g., a respective frame member, a common frame member, etc.) of the rolling basket frame 42. Accordingly, the rolling basket cylinder 50 is coupled to the rolling basket frame 42 via the mount 52 and the resilient elements 56. Furthermore, in the illustrated embodiment, resilient elements 56 are disposed between the mount 52 and the frame member 54 of the rolling basket frame 42. The resilient elements 56 are configured to enable the rolling basket frame 42 to rotate relative to the mount 52 and to urge the rolling basket frame 42 to rotate toward the illustrated undeflected position, which corresponds to an undeflected angle of the rolling basket frame 42 relative to the mount 52. During operation of the tillage implement 10, the rolling basket 44 is engaged with the soil, which may drive the rolling basket frame 42 to rotate relative to the mount 52 against the torque applied by the resilient elements 56. Accordingly, the resilient elements 56 may apply a torque to the rolling basket frame 42 while the rolling basket 44 is engaged with the soil. The downforce applied by the rolling basket 44 to the soil is based on the torque applied by the resilient elements 56 to the rolling basket frame 42, and the torque applied by the resilient elements 56 to the rolling basket frame 42 is based on the angular offset of the rolling basket frame 42 with respect to the illustrated undeflected position. Furthermore, the angular offset of the rolling basket frame 42 with respect to the undeflected position (e.g., with respect to the undeflected angle of the rolling basket frame 42 relative to the mount 52) is based on the angle of the rolling basket frame 42 relative to the main frame 12 and the extension of the rolling basket cylinder 50. The extension of the rolling basket cylinder 50 is adjustable, but may remain fixed/constant as the angular offset of the rolling basket frame 42 varies.

In the illustrated embodiment, four resilient elements 56 are disposed between the mount 52 and the frame member 54 of the rolling basket frame 42. However, in other embodiments, more or fewer resilient elements may be disposed between the mount and the frame member of the rolling basket frame (e.g., 1, 2, 3, 5, 6, or more). Furthermore, while resilient elements are configured to enable the rolling basket frame 42 to rotate relative to the mount 52 and to urge the rolling basket frame 42 to rotate toward the undeflected position in the illustrated embodiment, in other embodiments, other suitable element(s)/device(s) may be used to enable rotation of the rolling basket frame relative to the mount and to urge the rolling basket frame to rotate toward the undeflected position. For example, in certain embodiments, the rolling basket frame may be pivotally coupled to the mount, and a biasing element, such as a spring (e.g., coil spring, leaf spring, etc.), a pneumatic cylinder, etc., may urge the rolling basket frame to rotate toward the undeflected position. In addition, in embodiments in which the tillage implement includes multiple rolling basket cylinders for the rolling basket frame section, each rolling basket cylinder may be pivotally coupled to a respective mount (e.g., disposed about the frame member). Furthermore, in certain embodiments, the rolling basket cylinder (e.g., each rolling basket cylinder) may be directly pivotally coupled to the rolling basket frame (e.g., the tillage implement may not include any element(s)/device(s) configured to urge the rolling basket frame to rotate relative to the rolling basket cylinder(s)). While one section of the rolling basket frame 42 and one section of the rolling basket 44 are shown in FIG. 2 and discussed above, the structures and variations disclosed above may be applied to the other section(s) of the rolling basket frame/rolling basket. For example, in certain embodiments, a mount may be disposed about a frame member of another section of the rolling basket frame, a rolling basket cylinder may be pivotally coupled to the mount, and resilient elements may be disposed between the mount and the frame member.

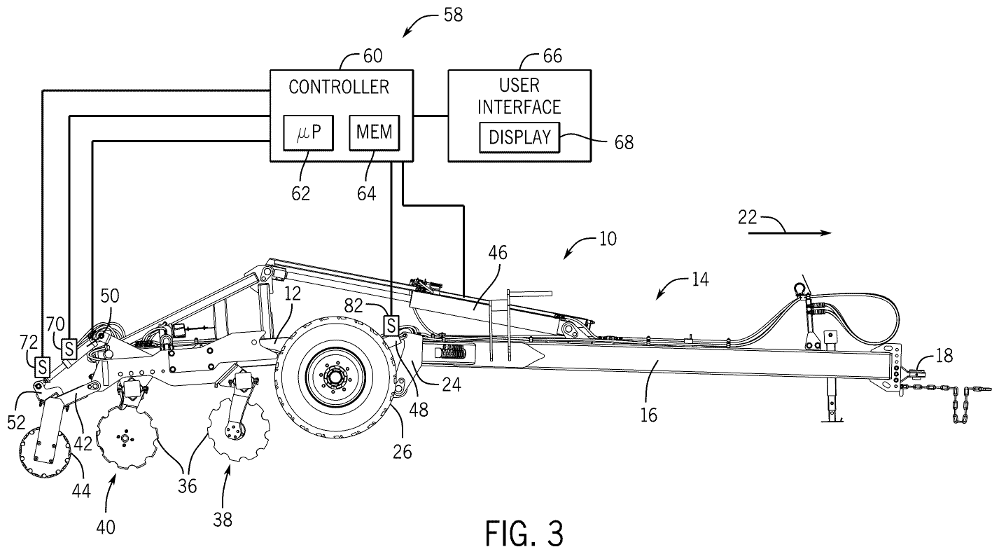

FIG. 3 is a schematic view of an embodiment of a control system 58 that may be employed within the tillage implement 10 of FIG. 1. In the illustrated embodiment, the control system 58 includes a controller 60 communicatively coupled to the tilt actuator 46, to the wheel frame actuator(s) 48, and to the rolling basket cylinder(s) 50. In certain embodiments, the controller 60 is an electronic controller having electrical circuitry configured to control the tilt actuator 46, the wheel frame actuator(s) 48, and the rolling basket cylinder(s) 50. In the illustrated embodiment, the controller 60 includes a processor, such as the illustrated microprocessor 62, and a memory device 64. The controller 60 may also include one or more storage devices and/or other suitable components. The processor 62 may be used to execute software, such as software for controlling the tilt actuator 46, the wheel frame actuator(s) 48, and the rolling basket cylinder(s) 50, and so forth. Moreover, the processor 60 may include multiple microprocessors, one or more “general-purpose” microprocessors, one or more special-purpose microprocessors, and/or one or more application specific integrated circuits (ASICs), or some combination thereof. For example, the processor 60 may include one or more reduced instruction set (RISC) processors.

The memory device 64 may include a volatile memory, such as random access memory (RAM), and/or a nonvolatile memory, such as read-only memory (ROM). The memory device 64 may store a variety of information and may be used for various purposes. For example, the memory device 64 may store processor-executable instructions (e.g., firmware or software) for the processor 62 to execute, such as instructions for controlling the tilt actuator 46, the wheel frame actuator(s) 48, and the rolling basket cylinder(s) 50, and so forth. The storage device(s) (e.g., nonvolatile storage) may include ROM, flash memory, a hard drive, or any other suitable optical, magnetic, or solid-state storage medium, or a combination thereof. The storage device(s) may store data, instructions (e.g., software or firmware for controlling the tilt actuator 46, the wheel frame actuator(s) 48, and the rolling basket cylinder(s) 50, etc.), and any other suitable data.

In the illustrated embodiment, the control system 58 includes a user interface 66 communicatively coupled to the controller 60. The user interface 66 is configured to receive input from an operator and to provide information to the operator. The user interface 66 may include any suitable input device(s) for receiving input, such as a keyboard, a mouse, button(s), switch(es), knob(s), other suitable input device(s), or a combination thereof. In addition, the user interface 66 may include any suitable output device(s) for presenting information to the operator, such as speaker(s), indicator light(s), other suitable output device(s), or a combination thereof. In the illustrated embodiment, the user interface 66 includes a display 68 configured to present visual information to the operator. In certain embodiments, the display 68 may include a touchscreen interface configured to receive input from the operator.

In the illustrated embodiment, the control system 58 includes a rolling basket pressure sensor 70 communicatively coupled to the controller 60. The rolling basket pressure sensor 70 is configured to output a first pressure sensor signal indicative of fluid pressure within the rolling basket cylinder 50. In the illustrated embodiment, the body of the rolling basket cylinder 50 is pivotally coupled to the main frame 12, and the rod of the rolling basket cylinder 50 is pivotally coupled to the mount 52. With the fluid flow to and from the rolling basket cylinder 50 blocked, the contact force between the rolling basket 44 and the soil (e.g., downforce) may drive the rolling basket frame 42 to rotate with respect to the undeflected position. As a result, the resilient elements may establish a torque between the rolling basket frame 42 and the mount 52, thereby urging the mount 52 to rotate. However, rotation of the mount 52 is blocked by the rolling basket cylinder 50, thereby establishing fluid pressure within the cap end of the rolling basket cylinder 50. Accordingly, in the illustrated embodiment, the rolling basket pressure sensor 70 is configured to output the first pressure sensor signal indicative of fluid pressure within the cap end of the rolling basket cylinder 50. The pressure within the cap end of the rolling basket cylinder 50 is based on the torque applied by the resilient elements. In certain embodiments, the body of the rolling basket cylinder may be pivotally coupled to the mount, and the rod of the rolling basket cylinder may be pivotally coupled to the main frame. In such embodiments, the pressure sensor may be configured to output the first pressure sensor signal indicative of fluid pressure within the rod end of the rolling basket cylinder.

Furthermore, in the illustrated embodiment, the control system 58 includes an angle sensor 72 communicatively coupled to the controller 60. The angle sensor 72 is configured to output an angle sensor signal indicative of an angle of the rolling basket frame 42 relative to the main frame 12. As previously discussed, the angular offset of the rolling basket frame 42 with respect to the undeflected position (e.g., with respect to the undeflected angle of the rolling basket frame 42 relative to the mount 52) is based on the angle of the rolling basket frame 42 relative to the main frame 12 and the extension of the rolling basket cylinder 50. In addition, the torque applied by the resilient elements to the rolling basket frame 42 is based on the angular offset of the rolling basket frame 42 with respect to the undeflected position. Accordingly, the angle of the rolling basket frame 42 relative to the main frame 12 is indicative of the torque applied by the resilient elements. The angle sensor 72 may include any suitable type(s) of sensor(s) configured to monitor the angle of the rolling basket frame 42 relative to the main frame 12 (e.g., rotary potentiometer(s), linear potentiometer(s), linear variable differential transformer(s) (LVDT), infrared sensor(s), etc.).

Furthermore, in the illustrated embodiment, the control system 58 includes one or more wheel pressure sensors 82 communicatively coupled to the controller 60. Each wheel pressure sensor 82 is configured to output a pressure sensor signal indicative of a pressure associated with one or more of the wheels 26, such as a fluid pressure within each wheel frame actuator 48. In the illustrated embodiment, the body of each wheel frame actuator 48 is pivotally coupled to the hitch frame 16 of the hitch assembly 14, and the rod of the wheel frame actuator 48 is pivotally coupled to the wheel frame 24. With the fluid flow to and from each wheel frame actuator blocked, the contact force between the wheels 26 and the soil surface (e.g., downforce) may urge the wheel frame 24 to rotate relative to the hitch frame 16. However, rotation of the wheel frame 24 is blocked by the wheel frame actuator(s) 48, thereby establishing fluid pressure within the cap end of each wheel frame actuator 48. Accordingly, in the illustrated embodiment, each wheel pressure sensor 82 is configured to output the second pressure sensor signal indicative of fluid pressure within the cap end of the respective wheel frame actuator 48. The pressure within the cap end of the wheel frame actuator 48 is based on the contact force between the wheels 26 and the soil surface (e.g., downforce). In certain embodiments, the body of each wheel frame actuator 48 may be pivotally coupled to the wheel frame, and the rod of the wheel frame actuator may be pivotally coupled to the hitch frame. In such embodiments, each pressure sensor may be configured to output the second pressure sensor signal indicative of fluid pressure within the rod end of the respective wheel frame actuator. In other embodiments, the one or more wheel pressure sensors may include other suitable types of pressure or force sensors, such as piezoelectric sensors, capacitive sensors, and the like, and may be attached to various parts of the tillage implement 10 (e.g., a wheel 26, the wheel frame 24, and so on).

In certain embodiments, the controller 60 is configured to receive the pressure sensor signal from the pressure sensor 70. In such embodiments, the controller 60 is configured to control the tilt force applied by the tilt actuator 46 to the main frame 12 to maintain the fluid pressure within a threshold fluid pressure range of a target fluid pressure. Maintaining the fluid pressure within the threshold fluid pressure range of the target fluid pressure may substantially maintain the torque applied by the resilient elements to the rolling basket frame 42, thereby substantially maintaining the downforce applied by the rolling basket 44 to the soil. As a result, the penetration depth of the disc blades 36 (e.g., at least the rear row 40 of disc blades 36) may be substantially maintained as the tillage implement 10 is towed along the field in the direction of travel 22 (e.g., as the tillage implement 10 encounters bumpy terrain). Accordingly, the disc blades 36 of the tillage implement 10 may break up the top layer of the soil at a consistent depth, thereby enhancing the effectiveness of tillage operations. For example, while the tillage implement 10 is operating within a region of denser soil, the controller may control the tilt actuator 46 to increase the tilt force applied to the main frame 12 to maintain the fluid pressure within the threshold fluid pressure range of the target fluid pressure, thereby increasing the longitudinal rigidity of the tillage implement 10. In addition, while the tillage implement 10 is operating within a region of less dense soil, the controller may control the tilt actuator 46 to decrease the tilt force applied to the main frame 12 to maintain the fluid pressure within the threshold fluid pressure range of the target fluid pressure, thereby reducing the longitudinal rigidity of the tillage implement 10.

In certain embodiments, the target fluid pressure within the rolling basket cylinder 50 may be input into the user interface 66 (e.g., to establish a desired contact force between the rolling basket 44 and the soil) as an initial target fluid pressure and/or determined by the controller 60 (e.g., based on the operation speed of the tillage implement, soil conditions, soil composition, seed type of a subsequent planting/seeding operation, etc.). Furthermore, the threshold fluid pressure range may be input into the user interface 66 and/or determined by the controller 60 (e.g., based on the operation speed of the tillage implement, soil conditions, soil composition, seed type of a subsequent planting/seeding operation, etc.).

In certain embodiments, the controller 60 is configured to receive the second pressure sensor signal from each wheel pressure sensor 82. In such embodiments, the controller 60 is configured to iteratively adjust the target fluid pressure based on the second pressure sensor signal. As such, the controller 60 is configured to iteratively control the tilt force applied by the tilt actuator 46 to the main frame 12 to maintain the fluid pressure within the threshold fluid pressure range of the target fluid pressure (e.g., as adjusted by the controller). Maintaining the fluid pressure within the threshold fluid pressure range of the target fluid pressure may substantially maintain a suitable force applied by the rolling basket 44 to the soil (e.g., downforce). As a result, the depth of the rolling basket 44 may be maintained at a suitable depth to substantially reduce or eliminate plugging as the tillage implement 10 is towed along the field in the direction of travel 22. For example, if the target fluid pressure is excessive such as to cause an impending plugging condition, the second pressure signal may indicate that pressure within the respective wheel frame actuator 48 has fallen below a minimum threshold pressure. The controller 60 may then adjust (e.g., decrease) the target fluid pressure accordingly, thus adjusting the tilt force applied by the tilt actuator 46 to the main frame 12.

In the illustrated embodiment, the tilt actuator 46 includes a hydraulic cylinder. Furthermore, in the illustrated embodiment, the body of the hydraulic cylinder is pivotally coupled to the hitch frame 16, and the rod of the hydraulic cylinder is pivotally coupled to the main frame 12. Accordingly, the controller is configured to control the fluid pressure within the cap end of the hydraulic cylinder to control the tilt force applied by the tilt actuator to the main frame. In certain embodiments, the controller may be configured to control the fluid pressure within the rod end of the hydraulic cylinder to control the stiffness of the tilt actuator (e.g., to adjust the dynamics/kinematics of the tillage implement as the tillage implement traverses a field). While the body of the hydraulic cylinder is pivotally coupled to the hitch frame 16 and the rod of the hydraulic cylinder is pivotally coupled to the main frame 12 in the illustrated embodiment, in certain embodiments, the body of the tilt cylinder may be pivotally coupled to the main frame, and the rod of the tilt cylinder may be pivotally coupled to the hitch frame. In such embodiments, the controller may be configured to control the fluid pressure within the rod end of the hydraulic cylinder to control the tilt force applied by the tilt actuator to the main frame. Furthermore, in such embodiments, the controller may be configured to control the fluid pressure within the cap end of the hydraulic cylinder to control the stiffness of the tilt actuator. Accordingly, regardless of the mounting direction of the hydraulic cylinder, the controller is configured to control the fluid pressure (e.g., tilt fluid pressure) at each end of the hydraulic cylinder to control the tilt force and the stiffness of the tilt actuator. While the tilt actuator 46 includes a hydraulic cylinder in the illustrated embodiment, in other embodiments, the tilt actuator may include a pneumatic cylinder, an electric linear actuator, etc.

For each cylinder of the tillage implement (e.g., including the rolling basket cylinder(s) and tilt cylinder in embodiments in which the tilt actuator includes a cylinder), the controller is communicatively coupled to the cylinder via a valve assembly of the control system. The valve assembly may include any suitable number of valves and any suitable type(s) of valve(s). Furthermore, the control system may include any suitable number of valve assemblies (e.g., a single valve assembly fluidly coupled to each cylinder, one valve assembly for each cylinder, etc.). The controller is configured to output control signal(s) to each valve assembly, and each valve assembly is configured to adjust fluid flow (e.g., fluid pressure, fluid flow rate, etc.) to the respective cylinder(s) fluidly coupled to the valve assembly. Accordingly, the controller is configured to control the cylinders via the valve assembly/assemblies.

In certain embodiments, the controller 60 is configured to limit the tilt force applied by the tilt actuator 46 to a maximum tilt force. For example, as the controller 60 is controlling the tilt force applied by the tilt actuator 46, the controller 60 may not control the tilt actuator 46 to apply a tilt force greater than the maximum tilt force, thereby limiting the stress on components of the tillage implement. The maximum tilt force may be stored within the controller 60 (e.g., input by the operator into the user interface 66, established by the manufacturer, etc.).

As previously discussed, in certain embodiments, the wheel frame 24 has multiple sections. In such embodiments, at least one wheel frame actuator 48 may be coupled to each section of the wheel frame 24, and the wheel frame actuators may be fluidly coupled to one another (e.g., in a parallel flow arrangement). Accordingly, the control system 58 may include a single wheel pressure sensor 82 (e.g., fluidly coupled to wheel frame actuator 48 and/or to one conduit/line fluidly coupled to the wheel frame actuator(s) 48). Additionally or alternatively, the control system may include multiple wheel pressure sensors (e.g., in embodiments in which each wheel frame actuator is independently controllable). In such embodiments, the controller may receive multiple wheel pressure signals, and the controller may control the tilt force based on a statistical analysis of the wheel pressure signals (e.g., mean, minimum, maximum, median, etc.).

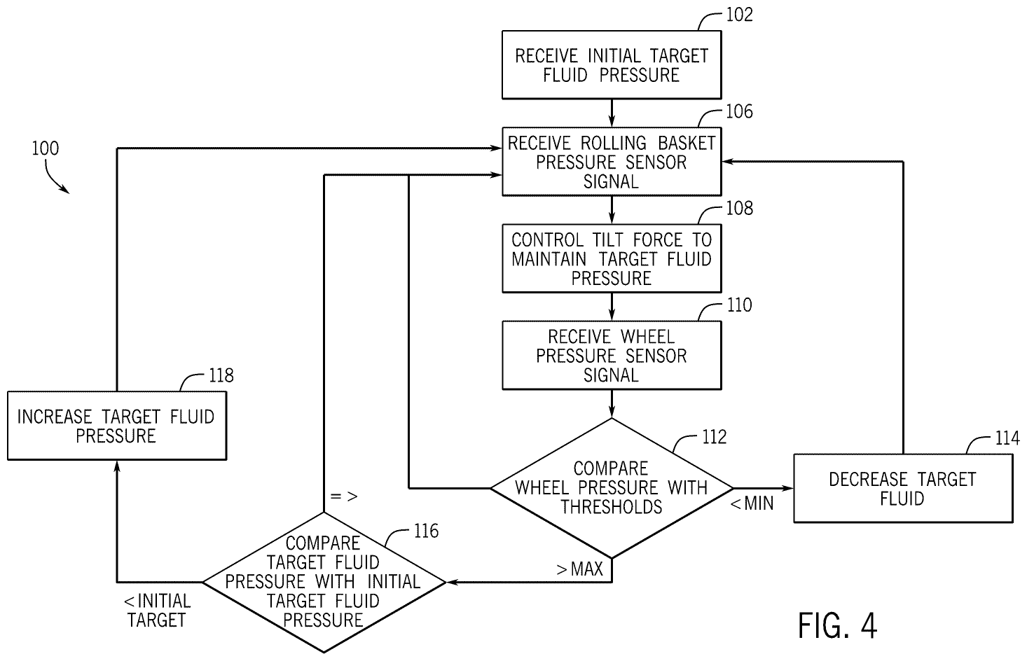

FIG. 4 is a flow diagram of an embodiment of a method for controlling a tilt actuator of a tillage implement based on a wheel pressure. The method 100 may be performed by the controller disclosed above with reference to FIG. 3 or any other suitable controller(s). Furthermore, the steps of the method 100 may be performed in the order disclosed herein or in any other suitable order. For example, certain steps of the method may be performed concurrently. In addition, in certain embodiments, at least one of the steps of the method 100 may be omitted.

In certain embodiments, the method 100 includes receiving an initial target fluid pressure, as represented by block 102. The initial target fluid pressure may be input, for example, by an operator of a tillage implement via a user interface communicatively coupled to a controller of the tillage implement. The following steps of the method 100 may be performed iteratively, as will be described below. In the illustrated embodiment, the method 100 includes receiving the first pressure sensor signal indicative of the fluid pressure within the rolling basket cylinder, as represented by block 106. As previously discussed, the pressure sensor signal may be received from the rolling basket pressure sensor.

In addition, the method 100 includes controlling the tilt force applied by the tilt actuator to the main frame to maintain the fluid pressure within the threshold fluid pressure range of the target fluid pressure, as represented by block 108. Maintaining the fluid pressure within the threshold fluid pressure range of the target fluid pressure may substantially maintain the penetration depth of the disc blades (e.g., at least the rear row of disc blades) as the tillage implement is towed along the field in the direction of travel (e.g., as the tillage implement 10 encounters bumpy terrain). As a result, the disc blades of the tillage implement may break up the top layer of the soil at a consistent depth, thereby enhancing the effectiveness of tillage operations. In embodiments in which the tilt actuator includes a hydraulic cylinder, the tilt fluid pressure at each end of the hydraulic cylinder may be controlled to control the tilt force and the stiffness of the tilt actuator, as discussed above with reference to FIG. 3.

Furthermore, the method 100 includes receiving the second pressure sensor signal indicative of a wheel pressure, as represented by block 110. As discussed herein, the wheel pressure may include a fluid pressure measured within one or more wheel frame actuators, or may include a pressure as measured by pressure sensors of the one or more wheels. The second pressure sensor may include multiple sensor signals from multiple wheel frame actuators or multiple pressure sensors of the one or more wheels. In these cases, the wheel pressure may be interpreted via a statistical analysis of the multiple sensor signals (e.g., mean, minimum, maximum, median, etc.). For example, a wheel frame actuator fluid pressure signal may include multiple signals received from multiple wheel frame actuators, and the wheel pressure may include an average of the multiple signals. In any case, the wheel pressure may then be compared to threshold pressures, as represented by block 112. The controller may determine that the wheel pressure is above a minimum threshold wheel pressure and below a maximum threshold wheel pressure, and may, in response, continue to receive rolling basket pressure sensor signals, control the tilt force to maintain the target fluid pressure, and so on, as represented by the blocks 106, 108, and the rest.

If, however, the wheel pressure is determined as being below the minimum threshold wheel pressure, the target fluid pressure of the rolling basket cylinder(s) may be decreased, as represented by block 114. The wheel pressure being below the minimum threshold wheel pressure may indicate that the wheels have lifted off the ground, for example. In response, the target fluid pressure may be decreased (e.g., by a decrease increment). Subsequently, the controller may continue to receive rolling basket pressure sensor signals, control the tilt force to maintain the target fluid pressure, and so on, as represented by block 106 and 108.

If the fluid pressure is determined as being above the maximum threshold pressure, the target pressure may be compared to an initial target fluid pressure (e.g., as specified by the operator), as represented by block 116. If the target pressure is less than the initial target fluid pressure, the target fluid pressure of the rolling basket cylinders may be increased, as represented by block 118. The fluid pressure being above the maximum threshold pressure may indicate that the one or more wheels are in contact with the ground and that the rolling basket is sufficiently supported by the main frame. If, however, the target fluid pressure is greater than or equal to the initial target fluid pressure, the target fluid pressure is not increased, and rolling basket pressure sensor signals may be received, as represented by block 106

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function) . . . ” or “step for (perform)ing (a function) . . . ”, it is intended that such elements are to be interpreted under 35 U.S.C. 112(f). However, for any claims containing elements designated in any other manner, it is intended that such elements are not to be interpreted under 35 U.S.C. 112(f).

1. A control system for an agricultural tillage implement, comprising:
a controller comprising a memory and a processor, wherein the controller is configured to:
receive a first pressure sensor signal indicative of a first fluid pressure within a rolling basket cylinder and a second pressure sensor signal indicative of a second fluid pressure within a wheel frame actuator, wherein the rolling basket cylinder is configured to couple to a main frame and to a rolling basket frame, the wheel frame actuator is configured to couple to a wheel frame and to a hitch assembly, and the wheel frame actuator is configured to control a position of the wheel frame relative to the hitch assembly;
decrease a target fluid pressure in response to the second fluid pressure being below a minimum wheel frame actuator pressure threshold; and
control a tilt force applied by a tilt actuator to the main frame to maintain the first fluid pressure within a threshold fluid pressure range of the target fluid pressure, wherein the tilt actuator is configured to couple to the hitch assembly and to apply the tilt force to the main frame.

2. The control system of claim 1, comprising a pressure sensor communicatively coupled to the controller, wherein the pressure sensor is configured to output the first pressure sensor signal indicative of the first fluid pressure within the rolling basket cylinder.

3. The control system of claim 1, wherein the tilt actuator comprises a hydraulic cylinder, and the controller is configured to control a tilt fluid pressure at each end of the hydraulic cylinder to control the tilt force and a stiffness of the tilt actuator.

4. The control system of claim 1, wherein the controller is configured to:
increase the target fluid pressure in response to the fluid pressure within a respective wheel frame actuator being above a maximum wheel frame actuator pressure threshold.

5. The control system of claim 4, wherein the controller is configured to:
receive a signal indicative of an initial target fluid pressure; and
increase the target fluid pressure in response to the target fluid pressure being below the initial target fluid pressure.

6. The control system of claim 5, wherein the initial target fluid pressure is input by an operator of the agricultural tillage implement.

7. The control system of claim 1, wherein the controller is configured to limit the tilt force applied by the tilt actuator to a maximum tilt force.

8. The control system of claim 1, wherein the second fluid pressure within the wheel frame actuator being below the minimum wheel frame actuator pressure threshold corresponds to a wheel coupled to the wheel frame not having contact with a ground surface.

9. A tillage implement, comprising:
a main frame configured to support a plurality of disc blades;
a rolling basket frame pivotally coupled to the main frame, wherein the rolling basket frame is configured to support a rolling basket;
a hitch assembly pivotally coupled to the main frame;
a wheel frame pivotally coupled to the hitch assembly, wherein the wheel frame is configured to support a plurality of wheels;
one or more wheel frame actuators coupled to the wheel frame and the hitch assembly, wherein each of the one or more wheel frame actuators is configured to control a position of one or more wheels of the plurality of wheels relative to the hitch assembly;
a rolling basket cylinder coupled to the main frame and to the rolling basket frame;
a tilt actuator coupled to the hitch assembly and to the main frame, wherein the tilt actuator is configured to apply a tilt force to the main frame; and
a control system comprising a controller having a memory and a processor, wherein the controller is communicatively coupled to the tilt actuator, and the controller is configured to:
receive a first pressure sensor signal indicative of a first fluid pressure within the rolling basket cylinder and a second pressure sensor signal indicative of a second fluid pressure within a wheel frame actuator;
decrease a target fluid pressure in response to the second fluid pressure being below a wheel frame actuator pressure threshold; and
control the tilt force applied by the tilt actuator to the main frame to maintain the first fluid pressure within a threshold fluid pressure range of a target fluid pressure.

10. The tillage implement of claim 9, wherein the control system comprises a pressure sensor communicatively coupled to the controller, and the pressure sensor is configured to output the first pressure sensor signal indicative of the first fluid pressure within the rolling basket cylinder.

11. The tillage implement of claim 9, wherein the controller is configured to limit the tilt force applied by the tilt actuator to a maximum tilt force.

12. The tillage implement of claim 9, wherein the tilt actuator comprises a hydraulic cylinder, and the controller is configured to control a tilt fluid pressure at each end of the hydraulic cylinder to control the tilt force and a stiffness of the tilt actuator.

13. The tillage implement of claim 9, wherein the controller is configured to:
receive a signal indicative of an initial target fluid pressure; and
increase a target fluid pressure in response to the second fluid pressure being above a maximum wheel frame actuator pressure threshold and the target fluid pressure being below the initial target fluid pressure.

14. The tillage implement of claim 13, wherein the initial target fluid pressure is input to via a user interface communicatively coupled to the controller and configured to receive input from an operator of the tillage implement.

15. The tillage implement of claim 9, wherein the one or more wheel frame actuators being below the wheel frame actuator pressure threshold corresponds to the plurality of wheels not being in contact with an agricultural surface.

16. A method, comprising:
receiving, via a controller comprising a memory and a processor, a first pressure sensor signal indicative of a first fluid pressure within a rolling basket cylinder, wherein the rolling basket cylinder is configured to couple to a main frame and to a rolling basket frame of an agricultural tillage implement;
receiving, via the controller, a second pressure sensor signal indicative of a wheel pressure associated with one or more wheels of the agricultural tillage implement;
decreasing, via the controller, a target fluid pressure in response to the wheel pressure being below a minimum wheel pressure threshold; and
controlling, via the controller, a tilt force applied by a tilt actuator to the main frame to maintain the first fluid pressure within the rolling basket cylinder within a threshold fluid pressure range of a target fluid pressure, wherein the tilt actuator is configured to coupled to a hitch assembly of the agricultural tillage implement and to apply the tilt force to the main frame.

17. The method of claim 16, wherein the wheel pressure comprises a second fluid pressure within a wheel frame actuator, and wherein the wheel frame actuator is configured to couple to a wheel frame and to a hitch assembly, and wherein the wheel frame actuator is configured to control a position of the wheel frame relative to the hitch assembly.

18. The method of claim 16, comprising:
receiving, via the controller, a signal indicative of a target initial fluid pressure; and
increasing, via the controller, the target fluid pressure in response to the wheel pressure being above a maximum wheel pressure threshold and the target fluid pressure being below an initial target fluid pressure.

19. The method of claim 18, wherein the target initial fluid pressure is input by an operator of the agricultural tillage implement via a user interface communicatively coupled to the controller.

20. The method of claim 16, wherein the wheel pressure being below a minimum wheel pressure threshold corresponds to the one or more wheels not having contact with a ground surface.
